(19) United States
(12) Patent Application Publication
(10) Pub. No.: US 2026/0093963 A1
(43) Pub. Date: Apr. 2, 2026

(54) AMPLIFYING NON-LINEARITY IN FEEDFORWARD NETWORK MODULE

(71) Applicant: XILINX, INC., San Jose, CA (US)

(72) Inventors: Yixing XU, Beijing (CN); Chao LI, Beijing (CN); Dong LI, Beijing (CN); Xiao SHENG, Beijing (CN); Fan JIANG, Beijing (CN); Lu TIAN, Beijing (CN); Ashish SIRASAO, San Jose, CA (US); Emad BARSOUM, Redmond, WA (US)

(21) Appl. No.: 18/957,488

(22) Filed: Nov. 22, 2024

Related U.S. Application Data
(60) Provisional application No. 63/701,433, filed on Sep. 30, 2024.

(51) Int. Cl. G06N 3/048; G06N 3/0499

(52) U.S. Cl. CPC G06N 3/048; G06N 3/0499

(57) ABSTRACT

Embodiments herein relate to modifying the framework of an FFN module of a machine learning model. Modifications include an improved nonlinear function of that aims to decrease the number of hidden dimensions of the FFN module, thereby reducing the computational cost.

### CROSS REFERENCE TO RELATED APPLICATION

This application claims priority to the U.S. Provisional Patent Application Ser. No. 63/701,433 filed Sep. 30, 2024 of which is incorporated herein by reference in its entirety.

### TECHNICAL FIELD

The embodiments presented relate to feed forward network (FFN) modules of machine learning (ML) models.

### BACKGROUND

An FFN module refers to a core building block of various ML models. In a FFN module, information flows from the input layer, through “hidden” layers with different functions, to an output layer. FFN modules do not incorporate feedback loops. Layers of an FFN module can form a hierarchy where earlier layers of the FFN module can capture simpler features (such as edges in images), and deeper layers can capture more complex patterns. FFN modules are used in various tasks such as classification, regression, and feature extraction, among others. In practice, using FFN modules provide nonlinearity to their input, with the level of nonlinearity corresponding to the number of hidden layers within the FFN module.

### SUMMARY

According to some embodiments, a method including: processing a matrix at a fully connected (FC) layer of a feed forward network (FFN) layer of a machine learning (ML) model to output a second matrix, where the second matrix comprises a channel dimension; applying a first nonlinearity function to the second matrix to generate a first result, where the first nonlinearity function applies nonlinearity to the channel dimension of the second matrix; applying a second nonlinearity function to the second matrix to generate a second result, where the second nonlinearity function applies nonlinearity to the channel dimension of the second matrix; and concatenating the first result and the second result.

According to some embodiments, a system including: one or more processors; and one or more memories configured to store an application, which, when executed by a combination of the one or more processors, causes the combination of the one or more processors to perform an operation, the operation including: processing a matrix at a fully connected (FC) layer of a feed forward network layer of a machine learning (ML) model to output a second matrix, where the second matrix comprises a channel dimension; applying a first nonlinearity function to the second matrix to generate a first result, where the first nonlinearity function applies nonlinearity the channel dimension of the second matrix; applying a second nonlinearity function to second matrix to generate a second result, where the second nonlinearity function applies nonlinearity the channel dimension of the second matrix; and concatenating the first result and the second result.

According to another embodiment, a computer-readable storage medium having computer-readable program code embodied therewith, the computer-readable program code executable by one or more computer processors to: process a matrix at a fully connected (FC) layer of a feed forward network layer of a machine learning (ML) model to output a second matrix, wherein the second matrix comprises a channel dimension; apply a first nonlinearity function to the second matrix to generate a first result, where the first nonlinearity function applies nonlinearity the channel dimension of the second matrix; apply a second nonlinearity function to second matrix to generate a second result, where the second nonlinearity function applies nonlinearity the channel dimension of the second matrix; and concatenate the first result and the second result.

### BRIEF DESCRIPTION OF DRAWINGS

FIG. 1 illustrates an FFN module, according to some embodiments.

FIG. 2A illustrates an FFN module, according to some embodiments.

FIG. 2B illustrates an FFN module, according to some embodiments.

FIG. 3 illustrates a flowchart of an FFN module, according to some embodiments.

FIG. 4 illustrates graphs representing a nonlinearity function of an FFN module, according to some embodiments.

### DETAILED DESCRIPTION

As mentioned, FFN models provide nonlinearity to their input. However, to achieve a high level of nonlinearity, a large number of hidden layers within the FFN are implemented. A robust model that implements a relatively large amount of nonlinearity can be computationally expensive to use.

Embodiments herein relate to modifying the framework of an FFN module of a machine learning model. Modifications include an improved nonlinear function of that aims to decrease the number of hidden dimensions of the FFN module, thereby reducing the computational cost.

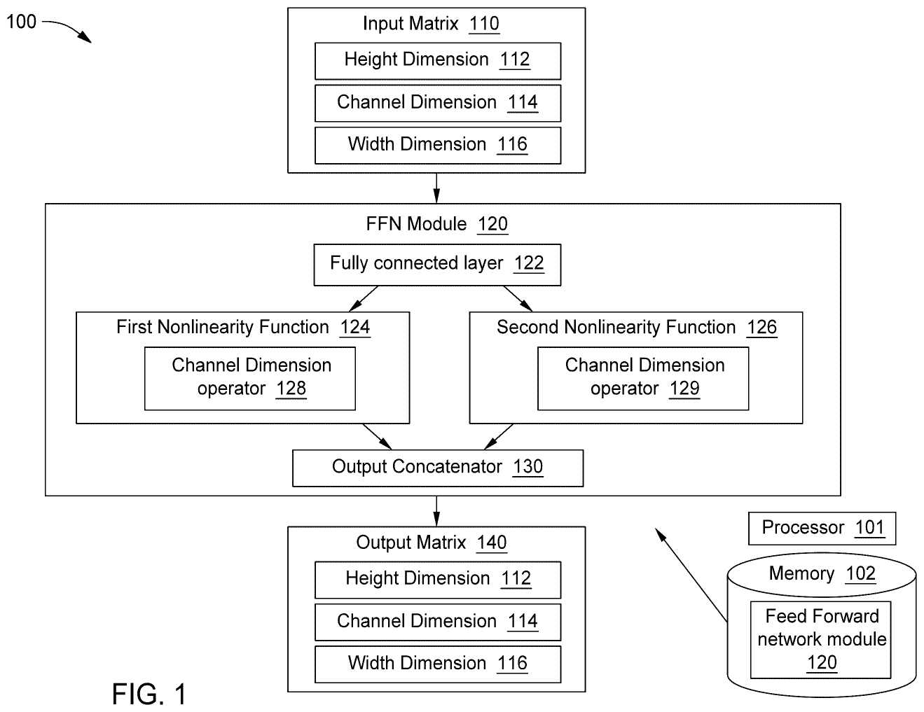

FIG. 1 illustrates an FFN module 120 where a relatively high degree of nonlinearity is produced by concatenating the results from two internal nonlinearity functions within one FFN module.

The FFN module 120 can be implemented on a computing system with a processor 101, and a memory 102. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 102 generally includes program code for performing various functions related to use of the FFN module 120. The program code is generally described as various functional “applications” or “modules” within the memory 102, although alternate implementations may have different functions and/or combinations of functions. Within the memory 102, the FFN module 120 facilitates applying nonlinearity to its input. This is discussed further, below.

The input matrix 110 contains a height dimension 112, a channel dimension 114 and a width dimension 116. This 3-dimensional structure is relevant for FFNs of ML models such as convolutional neural networks (CNNs), vision transformers, large language models (LLMs) among other types of models.

The input matrix 110 can represent data in a grid-like format, where the width dimension 116 and the height dimension 112 correspond to spatial dimensions such as pixel height and width of an image (among other things), and the channel dimension 114 represents the number of feature maps or channels (e.g. red green blue (RGB) channels in an image or learned feature maps in deeper layers).

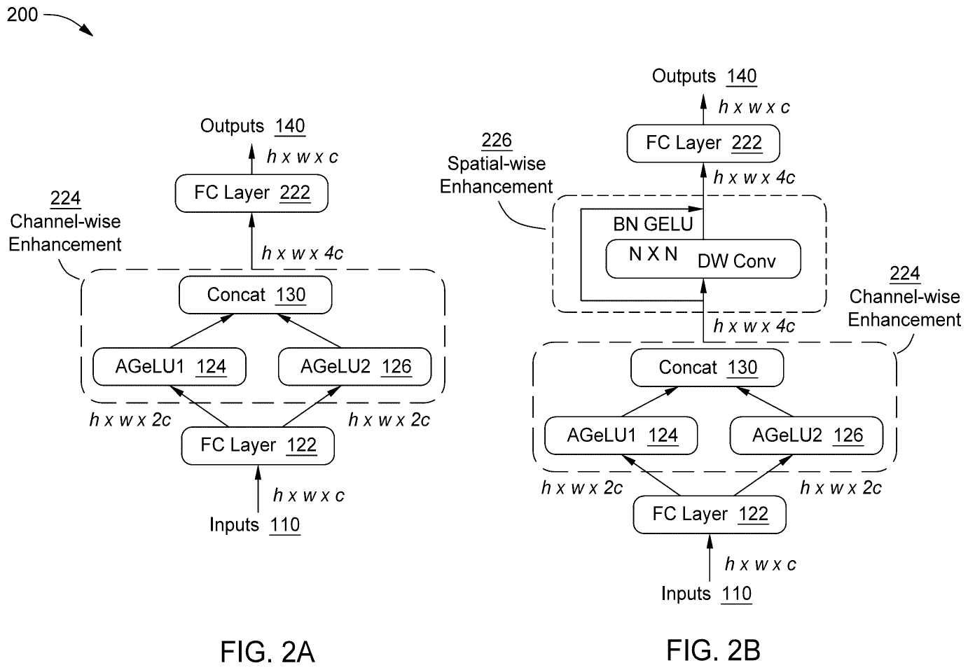

The FFN module 120 receives the input matrix 110 at a fully connected layer 122 that transforms the input matrix 110 data into a different representation of data than what was inputted, combining the learned features from the previous layers of the machine learning model the FFN module 120 is implemented on. In the FFN module 120, the fully connected layer 122 can output a representation of the input matrix 110 for a first nonlinearity function 124 and a representation for a second nonlinearity function 126. The representation used by the first nonlinearity function 124 may be the same representation or a different representation than the representation used by the second nonlinearity function 126. The first nonlinearity function 124 and the second nonlinearity function 126 operate on the channel dimensions 114 of the input matrix 110. The first nonlinearity function 124 and the second nonlinearity function 126 are described in more detail in FIG. 2A.

The first nonlinearity function 124 and the second nonlinearity function 126 contain architectures that operate on the channel dimensions 114 of the input matrix 110. The architecture is referred to as the channel dimension operator 128 and channel dimension operator 129 respectively.

The channel-wise operations are performed by the channel dimension operator 128 and the channel dimension operator 129. Channel-wise operations refer to operations applied independently across the different channels of an input, treating each channel separately without mixing information between them. For example, in tasks involving multi-channel data, such as images or feature maps where data can have multiple channels, each of the multiple channels can be operated on individually. For example, in an RGB image, a channel wise operation, such as applying a nonlinear activation function, may apply the function independently to the red channel, green channel, and blue channel without combining information between them. More details regarding the operations applied to the channel dimensions is described in FIG. 2A.

The data outputted by the first nonlinearity function 124 and the second nonlinearity function 126 are combined in a mathematical operation by the output concatenator 130.

More details regarding the FNN module 120 are described in FIGS. 2A and 2B.

The FFN module 120 outputs the result of the output concatenator 130 as an output matrix 140. The output matrix 140 also contains a height dimension 112, a width dimension 116, and a channel dimension 114 similar to the input matrix 110.

FIG. 2A illustrates nonlinearity being applied to the input matrix 110 by the FFN module 120. The fully connected layer 122 receives the input matrix 110 as described in FIG. 1. The height dimension, width dimension, and channel dimension are shown in the figure. The fully connected layer 122 provides input to the first nonlinearity function 124 and to the second nonlinearity function 126. In this example, the input provided by the fully connected layer 122 to the first nonlinearity function 124 includes double the amount of channel dimensions than the number of channel dimensions of the original input matrix 110. Likewise, the input provided by the fully connected layer 122 to the second nonlinearity function 124 also includes double the amount of channel dimensions than the number of channel dimensions of the original input matrix 110.

In some embodiments, the first nonlinearity function 124 is referred to as AGeLU1 and the second nonlinearity function 126 is referred to as AGeLU2.

AGeLU refers to the following nonlinearity elements of the FFN 120 which has been created such that two separate nonlinearity functions are applied to the input matrix??, and the results of the two nonlinearity functions are capable of being concatenated together such that a more linearity can be achieved by using the functions individually. The concatenation refers to combining the results from AGeLU1 (the first nonlinearity function) and AGeLU2 (the second nonlinearity function) where second nonlinearity function can be derived from the first nonlinearity function. This AGeLU improves the functioning of the FFN module by enabling the hidden dimensions of the FFN module to be effectively reduced.

An arbitrary nonlinearity function is defined as

$${∅}^{′} ( x ) = β∅ ( α x + γ ) + θ$$

in which x is the input of the arbitrary nonlinear function, α and β are learnable coefficients before and after applying the basic nonlinear function φ(·), and γ and θ are learnable biases.

The FFN module incorporates two AGeLU functions (AGeLU1 and AGeLU2).

The results of two AGeLU functions are concatenated, producing an output with a channel dimension quadruple the size of the channel dimension of the original input matrix 110.

An embodiment of the FFN module 120 is be implemented as

$${Y}^{′} = AFFN ( X ) = concat ( AGeLU ( {XW}^{d} ) , {AGeLU}^{′ ( {XW}^{d} )} ) ( {W}^{e} ) ,$$

Where AFFN is a term representing the FFN module 120, and where

$${W}^{d} = \{ {w}_{j}^{d} \} ∈ {ℝ}^{C \times \frac{{c}^{′}}{2}} and {W}^{e} = \{ {w}_{ij}^{e} \} ∈ {ℝ}^{{C}^{″} \times C}$$

are two weight matrices of two fully connected layers, and AGeLU(·) and AGeLU′(·) are two nonlinear functions with different parameters. The fully connected layer 122 outputs double the channel dimension output than the original inputted matrix 110. This effectively reduces the parameters of the ML model the FFN module 120 is being deployed on, increasing efficiency. In some embodiments, the FFN module 120 can be treated as a linear combination of C′ different nonlinear functions. The input matrix 110 X can be degraded into an input vector x∈ [symbol] ^{c}, and in its element wise form:

$${t}_{0} = x {W}^{d} = {( {\sum }_{i = 1}^{C} {W}_{{ic}^{′}}^{d} {x}_{i} )}_{{c}^{′} = i}^{\frac{{c}^{′}}{2}} \\ {t}_{1} = AGeLU ( {t}_{0} ) = {( {β}_{{c}^{′}} GeLU ( {α}_{{c}^{′}} {\sum }_{i = 1}^{C} {w}_{{ic}^{′}}^{d} {x}_{i} + {γ}_{{c}^{′}} ) + {θ}_{{c}^{′}} )}_{{c}^{′} = 1}^{\frac{{c}^{′}}{2}} \\ {t}_{1}^{′} = AGeLU ( {t}_{0} ) = {( {β}_{{c}^{′}}^{′} GeLU ( {α}_{{c}^{′}}^{′} {\sum }_{i = 1}^{C} {w}_{{ic}^{′}}^{d} {x}_{i} + {γ}_{{c}^{′}}^{′} ) + {θ}_{{c}^{′}}^{′} )}_{{c}^{′} = 1}^{\frac{{c}^{′}}{2}} \\ {t}_{2} = concat ( {t}_{1} , {t}_{1}^{′} ) = {{( {β}_{{c}^{′}}^{′} GeLU ( {α}_{{c}^{′}} {\sum }_{i = 1}^{C} {w}_{i , f ( {c}^{′} )}^{d} {x}_{i} + {γ}_{{c}^{′}} ) + {θ}_{{c}^{′}} )}_{{c}^{′} = 1}^{{C}^{′}}}^{′} \\ {y}^{′} = {t}_{1} {W}^{e} = {( {\sum }_{j = 1}^{{C}^{′}} {w}_{j c}^{e} \cdot [ {β}_{j} GeLU ( {α}_{j} {\sum }_{i = 1}^{C} {w}_{i , f ( j )}^{d} {x}_{i} + {γ}_{j} ) + {θ}_{j} ] )}_{c = 1}^{C} , = {( {\sum }_{j = 1}^{{C}^{′}} {w}_{j c}^{′ e} GeLU ( {m}_{{cj}^{{X}_{c}}}^{′} + {n}_{cj}^{′} ) + {θ}_{j} )}_{c = 1}^{C} ,$$

where

$${α}_{1}^{′} , … , {α}_{\frac{{c}^{′}}{2}}^{′} {=}^{Δ} {α}_{\frac{{c}^{′}}{2} + 1} , … , {α}_{C ,}$$

(the same to β′, γ′ and θ′),

$$f ( x ) = x - \frac{{C}^{′}}{2} \cdot {𝕀}_{x > \frac{{c}^{′}}{2}}$$

in which ]] is the indicator function,

$${w}_{jc}^{′ e} = {w}_{jc}^{e} \cdot {β}_{j} , {m}_{cj}^{′} = {w}_{c , f ( j )}^{d} and \\ {n}_{cj}^{′} = func ( {x}_{1} , … , {x}_{c - 1} , {x}_{c + 1} , … xc ) = {\sum }_{i = 1 , i \neq c}^{C} {w}_{i , f ( j )}^{d} x i + {γ}_{j} .$$

With this form of the FFN module 120, each element y′c in y′ can also be treated as a linear combination of C′ different nonlinear functions to the input element xc, each with distinct scales and biases. Each scale is a learnable weight independent to the input while each bias is dependent on other input elements.

FIG. 2B illustrates nonlinearity being applied to the input matrix 110 by the FFN module 120 with an additional special wise enhancement layer. The elements of the channel wise enhancement 224 portion of the FFN module 120 remain the same as in FIG. 2A. However, FIG. 2B includes a special wise enhancement 226 module.

The special wise enhancement module 226 performs mathematical operations on the spatial dimensions (the height dimension 112 and the width dimension 116) of the input matrix 110. The nonlinearity is enhanced through spatial information.

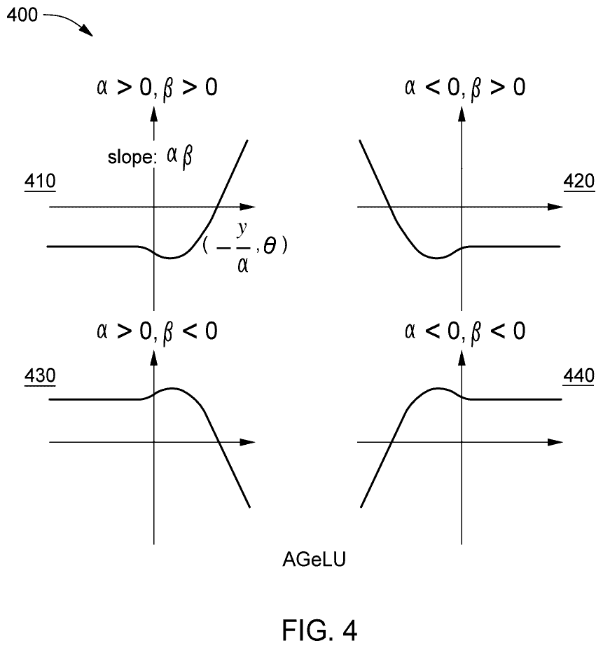

Within the spatial-wise enhancement 226 module, the mathematical operation is formulated as:

$${∅}_{s} ( {x}_{h , w , c} ) = {\sum }_{i , j ∈ \{ - n , n \}} {a}_{i , j , c} ∅ ( {x}_{i + h , j + w , c} + {b}_{c} )$$

where ø(·) is the activation function. Depicted in the spatial-wise enhancement 226 module is an arbitrary n×n depth wise (DW) convolution operation function, as well as a batch normalization operation that is applied to the input. This means that the DW convolution operation function after the non-linear function utilizes the spatial information and enhances non-linearity by learning global information from its neighbors. Thus, the FFN module 120 is enhanced by introducing a DW Block (DW Conv with batch normalization (BN) and GeLU) within the special wise enhancement module 226, after AGeLU. This forms a further improved FFN module 120 as shown in FIG. 4. The FFN module 120 has a channel-wise enhancement module 224 that includes the AGeLU function and concatenation operation from the output concatenator 130 to extend non-linearity through channel dimension 114. The FFN module 120 of FIG. 2B also includes the spatial-wise enhancement module 226 with a DW convolution operation function to enhance non-linearity with spatial information.

Both FIGS. 2A and 2B send the outputted matrix, which has quadruple the number of channel dimensions 114 than the original input matrix 110, through a second fully connected layer 222. The second fully connected layer 222 outputs an output matrix 140 where the number of channel dimensions 114 are reduced back to the number of channel dimensions 114 present in the input matrix 110.

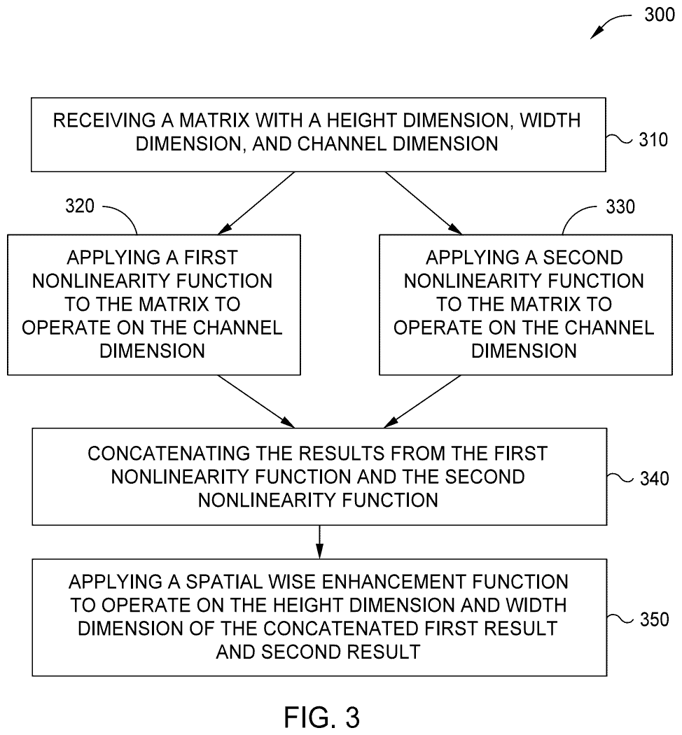

FIG. 3 illustrates a flowchart of the steps the FFN module 120 takes.

At block 310, the fully connected layer 122 receives an input matrix with a height dimension, width dimension and channel dimension. As mentioned in FIG. 2, the fully connected layer sends a first output matrix with double the channel dimensions to a first nonlinearity function, and a second output matrix, also with double the channel dimensions, to a second nonlinearity function.

At block 320, the FFN module applies the first nonlinearity function to an output of the fully connected layer, and at block 330, the FFN module applies the second nonlinearity function to the second output of the fully connected layer.

As described in FIG. 1, a nonlinearity function is a mathematical operation applied to introduce nonlinearity to an ML model. Nonlinear functions allow the ML model to learn more complex patters and relationships by transforming their input in ways that make the model capable of representing a wide variety of functions. By applying nonlinear functions, the ML model can learn more abstract features and solve a broader range of tasks, from image recognition to natural language processing, among other things.

At block 340, the output concatenator 130 concatenates the result from the first nonlinearity function and the second nonlinearity function. As described in FIG. 2A, concatenating the results of the first and second nonlinearity functions within the channel wise enhancement module (as shown in FIGS. 2A and 2B) ensures a strong level of nonlinearity is applied. Further processing can be applied to the concatenated result.

At block 350, in some embodiments, the spatial wise enhancement module 226 applies a DW convolutional operation on the concatenated result. As discussed in FIG. 2B, a DW convolution operation applies a separate filter to each of the spatial channels (height and width) individually. This reduces and computational cost and number of parameters in the ML model.

FIG. 4 illustrates the functioning of the AGeLU function of the channel wise enhancement module.

As depicted by the graphs AGeLU is more flexible than other modified nonlinear functions. AGeLU can provide a learnable slope of the function and switch the whole shape by using different positive and negative coefficients α and β. For example, 410 depicts a slope of AGeLU where α is positive and β is positive. That slope is different than the slope depicted in 420 where α is negative and β is positive. In 430, a is positive and β is negative, also outputting a different slope than 440, where α is negative and β is negative. FIG. 4 laid out in this way depicts the different learned slopes of AGeLU, where the first nonlinearity function outputs a learnable slope with a shape that can change according to the sign of coefficients used by the first nonlinearity function, and where the second nonlinearity function uses coefficients with different signs than the signs of the coefficients used in the first nonlinearity function.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
processing a matrix at a fully connected (FC) layer of a feed forward network (FFN) layer of a machine learning (ML) model to output a second matrix, wherein the second matrix comprises a channel dimension;
applying a first nonlinearity function to the second matrix to generate a first result, wherein the first nonlinearity function applies nonlinearity to the channel dimension of the second matrix;
applying a second nonlinearity function to the second matrix to generate a second result, wherein the second nonlinearity function applies nonlinearity to the channel dimension of the second matrix; and
concatenating the first result and the second result.

2. The method of claim 1, wherein the second matrix further comprises a height dimension and a width dimension.

3. The method if claim 2 further comprising:
applying a spatial wise enhancement function to the height dimension and width dimension of the concatenated first result and second result.

4. The method of claim 3, wherein the spatial wise enhancement function performs a depth wise convolutional operation.

5. The method of claim 4, wherein the convolutional operation function comprises applying a batch normalization operation and a nonlinearity function.

6. The method of claim 1, wherein the first nonlinearity function applies nonlinearity to double the channel dimensions of the first matrix and the second nonlinearity function applies nonlinearity to double the channel dimensions of the first matrix.

7. The method of claim 1, wherein concatenating the first result and the second result outputs a result with quadruple the channel dimensions of the first matrix.

8. The method of claim 1, wherein the second nonlinearity function is derived from the first nonlinearity function.

9. The method of claim 8 wherein the first nonlinearity function outputs a learnable slope with a shape, wherein the shape of the learnable slope can change according to a sign of coefficients used by the first nonlinearity function, and wherein the second nonlinearity function uses coefficients with different signs than the signs of the coefficients used in the first nonlinearity function.

10. A system comprising:
one or more processors; and
one or more memories configured to store an application, which, when executed by a combination of the one or more processors, causes the combination of the one or more processors to perform an operation, the operation comprising:
processing a matrix at a fully connected (FC) layer of a feed forward network layer of a machine learning (ML) model to output a second matrix, wherein the second matrix comprises a channel dimension;
applying a first nonlinearity function to the second matrix to generate a first result, wherein the first nonlinearity function applies nonlinearity the channel dimension of the second matrix;
applying a second nonlinearity function to second matrix to generate a second result, wherein the second nonlinearity function applies nonlinearity the channel dimension of the second matrix; and
concatenating the first result and the second result.

11. The system of claim 10, wherein the second matrix further comprises a height dimension and a width dimension.

12. The system of claim 11 further comprising:
applying a spatial wise enhancement function to the height dimension and width dimension of the concatenated first result and second result.

13. The system of claim 12, wherein the spatial wise enhancement function performs a depth wise convolutional operation.

14. The system of claim 13, wherein the convolutional operation function comprises applying a batch normalization operation and a nonlinearity function.

15. The system of claim 10, wherein the first nonlinearity function applies nonlinearity to double the channel dimensions of the first matrix and the second nonlinearity function applies nonlinearity to double the channel dimensions of the first matrix.

16. The system of claim 10, wherein concatenating the first result and the second result outputs a result with quadruple the channel dimensions of the first matrix.

17. The system of claim 10, wherein the second nonlinearity function is derived from the first nonlinearity function.

18. The system of claim 17 wherein the first nonlinearity function outputs a learnable slope with a shape, wherein the shape of the learnable slope can change according to a sign of coefficients used by the first nonlinearity function, and wherein the second nonlinearity function uses coefficients with different signs than the signs of the coefficients used in the first nonlinearity function.

19. A computer-readable storage medium having computer-readable program code embodied therewith, the computer-readable program code executable by one or more computer processors to:
process a matrix at a fully connected (FC) layer of a feed forward network layer of a machine learning (ML) model to output a second matrix, wherein the second matrix comprises a channel dimension;
apply a first nonlinearity function to the second matrix to generate a first result, wherein the first nonlinearity function applies nonlinearity the channel dimension of the second matrix;
apply a second nonlinearity function to second matrix to generate a second result, wherein the second nonlinearity function applies nonlinearity the channel dimension of the second matrix; and
concatenate the first result and the second result.

20. The computer-readable program code of claim 19, wherein the second matrix further comprises a height dimension and a width dimension.
